(19) United States
(12) Patent Application Publication
(10) Pub. No.: US 2014/0014590 A1
(43) Pub. Date: Jan. 16, 2014

(54) METHOD FOR PREPARING POTABLE WATER FROM CONTAMINATED CRUDE WATER

(71) Applicant: Suni A. Dalbø, Svenstrup (DK)

(72) Inventor: Suni A. Dalbø, Svenstrup (DK)

(73) Assignee: MicroDrop Aqua ApS, Faeroeme (DK)

(21) Appl. No.: 13/979,203

(22) PCT Filed: Jan. 4, 2012
(86) PCT No.: PCT/DK2012/050004

§ 371 Date: Sep. 24, 2013

(30) Foreign Application Priority Data
Jan. 11, 2011 (PA) 201170014

(51) Int. Cl. C02F 1/52

(52) U.S. Cl. CPC C02F 1/52
USPC 210/714

(57) ABSTRACT

The invention relates to a method for preparing potable water from crude water containing trace species contaminants. The method includes the steps of separating iron compounds and optionally other compounds from the crude water, contacting the water with a ferrous material, co-precipitating trace species upon aeration, and recovering drinking water.

### FIELD OF THE INVENTION

The present invention relates to a method for preparing potable water from crude water containing trace species contaminants.

### BACKGROUND

The contamination of groundwater with contaminant substances constitutes a major problem throughout the world. Where ever industrialised farming is carried out, the occurrence of pesticides and their breakdown products in groundwater is commonplace, but also the natural constitution of the underground itself may give rise to serious cases of contamination.

Thus, the presence of excess amounts of arsenic in more than 3 million groundwater wells of the world is linked to an increased risk of cancer and a range of other diseases and health problems in the affected areas, among which Bangladesh is often mentioned as a case of extreme affliction.

Due to the adverse health effects of arsenic, the WHO has lowered the recommended limit for arsenic in drinking water to 10 μg/L and in many industrialised countries the limit is now set at 5 μg/L. However, this has resulted in a large number of waterworks failing to comply with this limit using existing methods, and they have either had to close down or to invest in costly equipment for purification. It has been found a difficult task to reduce the content of arsenic from a frequently encountered level of 20-35 μg/l down to below 5 g/l at a reasonable cost.

Generally speaking, the problem is particularly pronounced in waterworks receiving groundwater with a low content of iron. In waterworks endowed with water rich in iron compounds this is sometimes less so, since arsenic under certain circumstances may be co-precipitated with oxidized iron compounds, when the water is treated in a conventional way by oxidation, typically aeration, until iron precipitates in sand filters or precipitation basins. However, it is not possible to remove arsenic by conventional oxidation of water, if the iron content of the water is not sufficient to ensure the desired co-precipitation of arsenic and other contaminants, including pesticides.

Remarkably, though, it has been observed in recent years that even some crude water supplies showing substantial concentrations of iron compounds are associated with contamination by arsenic and other trace species, which due to special circumstances do not—or only insufficiently—co-precipitate with iron upon oxidation.

DE 197 45 664 A1 discloses a method for treating arsenic-containing water, where the water flows through a reactor filled with an iron-containing granulate, said granulate being produced by mixing sand and iron powder and subsequent firing under exclusion of oxygen. in the reactor, the iron is oxidized by the oxygen dissolved in water generating Fe(III) ions, said ions together with As forming poorly soluble iron arsenate. Excess Fe(III) ions are precipitated as iron hydroxide binding As by adsorption. Thus, As binds to the granulate, wherefrom it has to be removed at suitable intervals. When precipitating Fe(III) compounds, the granulate uses agglomerates comparatively quickly and has to be exchanged frequently. The manufacture of the granulate requires work and energy. Moreover, the method requires the supply of additional oxygen to the reactor prior to treatment, if the treated groundwater is low in oxygen. in conclusion, the known method is work-intensive, complicated and expensive.

U.S. Pat. No. 5,951,869 describes a reactor, where water is treated with iron while simultaneously supplying oxygen. The treatment takes place in a fluid bed with iron particles as the source of iron. The use of a fluid bed, though, is an expensive and cumbersome enterprise.

The above-mentioned methods share the common feature that the iron treatment takes place concomitant with aeration or requires that the water has a suitable content of oxygen from the very start. Accordingly, there is an increased risk that the system is clogged by the precipitated oxidized iron compounds.

US 2009/0020482 marks a great step forward in the development of methods for removing contaminant trace species. Here, the water to be treated is contacted with an iron-containing material prior to aeration in order to increase the iron content of the water and thus improve co-precipitation of contaminants upon oxidation.

However, as alluded to in the above, under certain circumstances trace species contaminants do not co-precipitate with iron upon aeration, when a substantial level of iron is inherently present in the water to be treated. In that case, it has been found, co-precipitation of said contaminants cannot be brought about to a satisfactory degree, either, by contacting the crude water with an iron-containing material prior to aeration.

Accordingly, it has been natural to conclude that the concept of iron-enrichment and ensuing aeration is not practicable for removing arsenic and other undesired trace species from crude water being already rich in iron and all the same showing poor co-precipitation of the trace species upon aeration.

### SUMMARY

In view of the above, an object of the present invention is to provide a method for production of drinking water from crude water containing: trace species contaminants, wherein an effective and efficient removal of contaminants to a satisfactory level is attained, also when starting from iron-rich crude water from which the trace species contaminants do not co-precipitate sufficiently following aeration of the water. The method should furthermore be affordable, simple and environmentally friendly.

To meet this object, according to the invention a method is provided for producing drinking water from crude water containing trace species contaminants, said method comprising the steps of separating iron compounds and optionally other compounds from the crude water; contacting the water with an iron-containing material under sub-atmospheric oxygen partial pressure such as to enrich the water with Fe(II) compounds; co-precipitating at least a part of the trace species by treating the iron-enriched water under oxidizing conditions in an aerator; and recovering potable water by separation of the precipitate.

It has surprisingly been found by the inventors that the counterintuitive procedure of first clearing away, then adding iron is very effective in achieving a consistent removal of trace species contaminants, irrespective of the composition of the crude water to be treated.

With the finding of the inventors, an inexpensive and simple method is provided, which method requires only a small consumption of energy and no extraneous chemicals besides the iron-containing material, and wherein the purifying capacity of said material is turned fully to account.

Preferably, the initial separation of iron compounds and optionally other compounds from the crude water is effected in a sand filter. Additionally or alternatively, use of other filter types as well as settlement in a collection container may come into consideration.

According to a preferred embodiment of the invention, the iron-containing material is iron ore or metallic iron, including iron particles, iron filings or swarfs, or any other natural iron-containing material presenting an extended surface area. The Fe(II) compounds may be added to the water in a simple and reliable manner at acceptable cost by making use of these. Filings and swarfs are available as cheap waste products in the form of calcinated waste iron from cutting machines.

Preferably, the crude water is contacted with the iron-containing material in a closed container by pumping the water onto a bed of said iron-containing material. Throughout the present text, a “closed container” is to be understood as a container provided with openings for inlet and outlet of the water to be treated but with substantially no further openings during performance of the method according to the invention. By making use of a closed container, the observance of a sub-atmospheric oxygen partial pressure is facilitated, so that premature precipitation of Fe(III) compounds is minimized After contacting with the iron-containing material, the water may leave the bottom of the bed by means of suitable openings.

Advantageously, a layer of green rust is maintained on the surface of the iron-containing material.

Preferentially, the water is treated under oxidizing conditions by leading the water enriched with Fe(II) to the top of an aerator, optionally from a bed of iron-containing material mounted above the aerator, said aerator comprising a plate or one or more pipes with holes or slots for forming drops by flow of the water through the holes or slots at the initiation of the treatment process, and means arranged below said plate or pipe(s) for causing division of the drops by contact therewith, wherein the means for causing division of the drops comprise a plurality of tubular elements in the form of pipes having reticulate pipe walls, said tubular elements being placed in horizontal layers of several parallel tubular elements stacked in such a way that the longitudinal axes of the tubular elements in one layer are angularly displaced in relation to the longitudinal axes of the tubular elements in the one or more adjacent layers; and letting the water pass through said apparatus to the bottom thereof by the force of gravity.

Preferably, the aerator is fit up so that the longitudinal axes of the tubular elements in one layer are angularly displaced in relation to the longitudinal axes of the tubular elements in the one or more adjacent layers by an angle of approximately 90° C. In this way, good overall conditions for drop divisions to occur within the aerator are generated.

According to a preferred embodiment, the precipitate formed by treatment of the water in the aerator is separated from the drinking water by settlement in a collection container. Thereafter, the water may, if required, be led to one or more filters, e.g. sand filters, for further purification. It may, however, be relevant to return the water one or more times after precipitation and separation of the iron compounds for renewed contact with the iron-containing material, so that the content of trace species may be brought even further down. Alternatively, the water may be returned from the bottom of the aerator to its top with a view to enhanced aeration. Furthermore, air, optionally enriched in oxygen, may be led by passive or active flow in a vent pipe to the part of the aerator containing the tubular elements. In this manner, the degree of oxidation achieved in the aerator may be further regulated. The active supply of oxygen to the aerator could be used as an alternative to return of water from the bottom to the top of the aerator.

In an alternative embodiment, the precipitate is separated from the drinking water by direct dripping of water treated under oxidizing conditions onto an open sand filter without any intermediate settlement in a collection container, the precipitate being deposited on or near the upper surface of the sand filter. By ensuring a thorough aeration, a fully satisfactory flocculation of undesired compounds may in some instances be achieved, resulting in the formation of floc, which accumulates on the surface of the sand filter without infiltrating this, so that it can be easily removed.

Preferably, the co-precipitated trace species comprise arsenic and/or pesticides and/or non-volatile organic carbon (NVOC) such as humus. However, also other trace species such as chromium, mercury, MTBE (methyl t-butyl ether), and a range of non-pesticide chlorinated hydrocarbons may be co-precipitated.

### BRIEF DESCRIPTION OF THE DRAWING

In the following, a preferred embodiment of the invention will be illustrated by reference to the non-limiting figure.

FIG. 1 illustrates an embodiment of a plant for carrying out the method according to the invention.

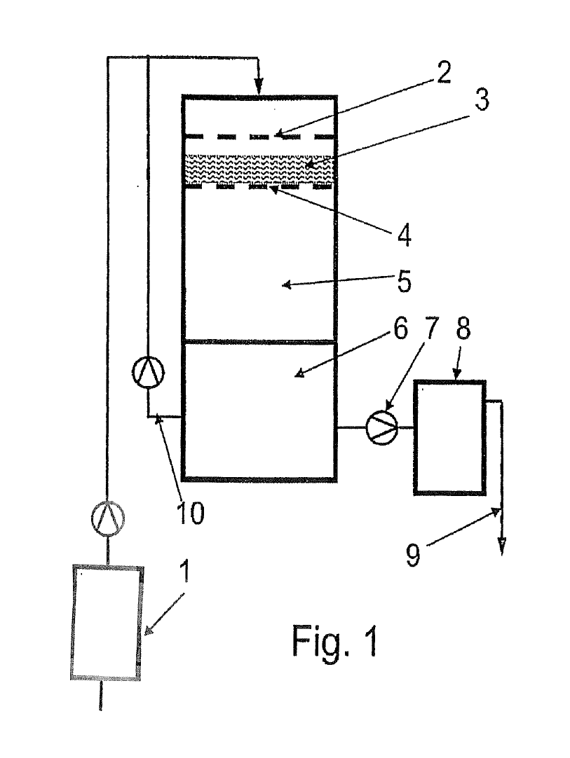

### DETAILED DESCRIPTION

Referring now to the figure, the main features of the illustrated plant are referenced by numbers as follows: 1 is a separator unit for separation of iron compounds and optionally other compounds from crude water, which is subsequently pumped to the top of the plant to a drip tray 2; 3 is a bed of iron swarfs arranged in a perforated plastic tray 4; 5 is an aeration chamber of an aerator; 6 is a collection container; 7 is a pump for leading the water to a sand filter 8; 9 is an outlet for pure drinking water; 10 is a pump for pumping treated water from the collection container 6 to the top of the plant for repeated treatment.

An overall description of a preferred embodiment of the method according to the invention will now be given.

An amount of crude water rich in iron is received in the separator unit 1. The separator unit in this embodiment is constituted by a closed, rapid sand filter made up of coarse sand and showing a high flow rate. It is regularly cleaned by backwashing. Alternatively, the sand filter might have been of the slow type relying on biological processes for its functioning and depending on the formation of a gelatinous layer of living organisms known as a “Schmutzdecke” in the uppermost few millimetres of the fine sand layer of the filter. In that case, the filter would have been rejuvenated by scraping off the top layer of the filter to expose a new layer of fresh sand.

Without wishing to be bound by a specific theory, it is believed that the very remarkable effect, which is conferred on the overall process by the treatment in the separator unit, is due to the fact that the water is freed from iron compounds in an inactive state, which are not able to bind trace species contaminants. If the crude water is saturated with such inactive compounds when contacted with the iron-containing material, the ferrous material, which would otherwise be released from the iron-containing material and precipitate together with contaminant trace species, is inhibited in exerting its function.

A possible explanation for the occasional inactivity of iron contained in the crude water might be its association with humic or other organic substances; also, the iron may be in the form of particles, which are shielded by bacterial encrustations.

From the separator unit 1 the water is pumped to the drip tray 2, wherefrom it is uniformly distributed across a bed of iron swarfs 3 approximately 10 cm thick, said bed being arranged in a perforated plastic tray 4. The dimensions of the bed of swarfs is determined so that the necessary uptake of iron compounds is assured for effective binding and co-precipitation of present arsenic, pesticides and other harmful trace species. The iron swarfs are available as a waste product of machining and have been calcinated prior to their use to remove residual cutting oil.

In order to maintain a layer of green rust on the surface of the iron swarfs, the oxygen concentration in the crude water at the time of contacting the iron swarfs is kept at a stable level close to 1 mg/L, while the corresponding pH of the water is also monitored and kept close to a value of 6.5.

It is assumed that the green layer formed in the present case is green rust of the kind, which incorporates carbonate ions. When corroding in the presence of an aqueous medium, iron starts by dissolving, and then reacts with the aqueous medium to form ferrous hydroxide Fe(OH)₂, where iron is divalent (Fe^{II}). Subsequently, this compound is transformed into the products of green colour, called “green rusts”, which is stable only at very low levels of oxygen. These green rusts at the same time contains divalent (Fe^{II}) and trivalent (Fe^{III}) iron. The composition of green rust formed in the presence of carbonate is [Fe^{II}₄Fe^{III}₂(OH)₁₂]²⁺ [CO₃2H₂O]²⁻.

In groundwater arsenic is present as arsenite (H₂As^{III}O₃₋) and/or arsenate (HAs^{v}O₄²⁻). Ions of arsenate adsorb to groups of —OH₂⁺ in the layer of green rust, while ions of arsenite apparently are not able to do so before being oxidized themselves to arsenate.

However, the green rust also contains the carbonate anion CO₃²⁻ and there is evidence to suggest that said carbonate ions may be exchanged by arsenite, which is then catalytically converted into arsenate by the content of Fe^{III} in the layer of green rust. This may explain the very effective removal of arsenic found when making use of green rust.

The iron-oxidizing, chemolithotropic bacteria Gallionella feruginea is also worth keeping on the iron swarfs. It has proven very useful in the removal of contaminant trace species as it precipitates Fe oxide in the form of ferrihydrite, which is a nanoporous hydrous ferric oxyhydroxide mineral presenting a large surface area of several hundred square meters per gram. In addition to its high ratio of surface area to volume, ferrihydrite also has a high density of local defects, such as dangling bonds and vacancies, which all confer to it a high ability to adsorb many environmentally important chemical species, including arsenic.

Also with a view to the workings of the green rust and the iron-oxidizing bacteria as described in the above, it is of great significance that undesirable iron compounds is separated from the crude water at the beginning of its treatment. Leaky crude water pipings as well as aquifers from strata rich in pyrite may give rise to premature biological oxidation of the iron present in the crude water, resulting in the development of an ochreous, slimy layer on the iron-containing material employed according to the invention and thus impeding its function.

Moreover, the initial separation treatment may have a beneficial effect in retaining excess amounts of CaCO₃, which would otherwise deposit as a passivation layer on the iron-containing material in case of a low content of CO₂ in the crude water.

The tray 4 is provided with a plurality of holes, e.g. having a diameter of 3-4 mm The water eventually arrives as drops in the top of the aeration chamber 5 for treatment of water. By the force of gravity said drops fall and impinge on a multitude of alternating layers of tubular elements, mutually displaced by 90°, so that the drops are divided into droplets. The formation of droplets results in a substantially larger drop surface area relative to drop volume, so that enhanced enrichment with oxygen can take place. The height of the stack of layers of tubular elements is adjusted so that the initial drops are divided at least 50-60 times and preferably 60-80 times when falling through the aeration unit, in which case a satisfactory oxygen saturation of up to 95% is assured. Alternatively, the water might have been aerated in a conventional device such as a splasher, a drip-type sheet, a cascade aerator or by blowing in air or oxygen.

The aerated droplets of water is directed to the collection container 6, where oxidized iron compounds settle together with co-precipitated trace species contaminants. The settled material may be removed from the collection container as necessary by light flushing. The water is fed to the sand filter 8 by means of the pump 7 to effect further precipitation of iron and trace species, and finally drinking water is taken out from the outlet 9. In many other cases, however, separation in the collection container would have been perfectly sufficient, so that the final sand filtration might have been dispensed with.

The concentration of arsenic and other trace species in the final drinking water product is monitored on a regular basis and when increasing towards the stipulated limit, the bed of iron swarfs 3 is replaced as an integral, closed unit together with its underlying plastic tray 4 and overlying drip tray 2. Accordingly, the method may be performed by persons without any specialised training and is usable in developing countries as well as in industrialised countries.

### EXAMPLE

A plant for performing the method according to the invention is installed at a waterworks receiving crude water showing a high content of arsenic (>20 μg/L) and a high content of iron (>1 mg/L), which is unable to co-precipitate arsenic, i.e. presenting quite difficult conditions for satisfactory removal of arsenic.

The content of oxygen in the water when contacting iron swarfs is kept below 1 mg/L. On the iron swarfs a layer of green rust is developed and maintained. During the development of said layer, a series of analyses is made of the content of iron in the water following passage through the initial separator unit as well as the iron swarfs. First a dramatic decline in iron to about 0.4 mg/L is seen, whereupon the level rises again during the course of two months to reach a level of more than 1 mg/L again. Now, however, the iron in the water is of another type, which is able to co-precipitate arsenic. This is reflected by the measured content of arsenic in the water following sedimentation and filtration in a sand filter; said content drops from the initial level of more than 20 μg/L to a level of less than the stipulated limit value of 5 μg/L.

1-7. (canceled)

8. A method for preparing potable water from crude water containing trace species contaminants, said method comprising the steps of:
i. separating iron compounds and optionally other compounds from the crude water;
ii. contacting the water with an iron-containing material under sub-atmospheric oxygen partial pressure such as to enrich the water with Fe(II) compounds;
iii. co-precipitating at least a part of the trace species by treating the iron-enriched water under oxidizing conditions in an aerator; and
iv. recovering potable water by separation of the precipitate.

9. The method according to claim 8, wherein the separation in step i.) is effected in a sand filter.

10. The method according claim 8, wherein the iron-containing material is iron ore or metallic iron, including iron particles, iron filings or swarfs, or any other natural iron-containing material presenting an extended surface area.

11. The method according to claim 8, wherein in step ii.) said contacting is effected by pumping the water into a closed container to a bed of said iron-containing material.

12. The method according claim 8, wherein in step iii.) said treating under oxidizing conditions in an aerator is achieved by leading the water enriched with Fe(II) to the top of an aerator, optionally from an iron-containing material being enclosed in a container mounted above the aerator, said aerator comprising a plate or one or more pipes with holes or slots for forming drops by flow of the water through the holes or slots at the initiation of the treatment process, and means for causing division of the drops by contact therewith, said means being arranged below said plate or pipe(s), wherein the means for causing division of the drops comprise a plurality of tubular elements in the form of pipes having reticulate pipe walls, said tubular elements being placed in horizontal layers of several parallel tubular elements stacked in such a way that the longitudinal axes of the tubular elements in one layer are angularly displaced in relation to the longitudinal axes of the tubular elements in the one or more adjacent layers; and letting the water pass through said aerator to the bottom thereof by the force of gravity.

13. The method according to claim 8, wherein in step iv.) the precipitate is separated from the drinking water by settlement in a collection container, optionally followed by further separation by treatment of the water in a sand filter.

14. The method according to claim 8, wherein the co-precipitated trace species comprise arsenic and/or pesticides and/or non-volatile organic carbon (NVOC).
